(19) United States
(12) Patent Application Publication
(10) Pub. No.: US 2011/0249530 A1
(43) Pub. Date: Oct. 13, 2011

(54) ARRANGING SENSOR ASSEMBLIES FOR SEISMIC SURVEYING

(76) Inventors: Qinglin Liu, Oslo (NO); Daniel Ronnow, Oslo (NO); Jon Magnus Soerli, Svelvik (NO); Julian Edward Kragh, Finchingfield (GB); Johan O.A. Robertsson, Cambridge (GB)

(21) Appl. No.: 12/757,133

(22) Filed: Apr. 9, 2010

(51) Int. Cl. G01V 1/28

(52) U.S. Cl. 367/58

(57) ABSTRACT

To perform seismic surveying, a plurality of sensor assemblies are provided, where each of multiple ones of the plurality of sensor assemblies has a seismic sensor and a divergence sensor, and where the divergence sensor is used to measure noise. In addition, the plurality of sensor assemblies are arranged in a layout designed to acquire seismic signals in a target sampling pattern, where the layout is independent of provision of sensor assemblies for noise acquisition.

### BACKGROUND

Seismic surveying is used for identifying subterranean elements of interest, such as hydrocarbon reservoirs, freshwater aquifers, gas injection zones, and so forth. In seismic surveying, seismic sources are placed at various locations on a land surface or sea floor, with the seismic sources activated to generate seismic waves directed into a subterranean structure.

The seismic waves generated by a seismic source travel into the subterranean structure, with a portion of the seismic waves reflected back to the surface for receipt by seismic receivers (e.g., geophones, accelerometers, etc.). These seismic receivers produce signals that represent detected seismic waves. Signals from the seismic receivers are processed to yield information about the content and characteristic of the subterranean structure.

A typical land-based seismic survey arrangement includes deploying an array of seismic receivers on the ground with the seismic receivers provided in an approximate grid formation. The seismic receivers can be multi-component geophones that enable the measurement of an incoming wavefield in three orthogonal directions (vertical z, horizontal inline x, and horizontal crossline y).

For land-based seismic surveying, various types of unwanted wavefields may be present, including ground-roll noise, such as Rayleigh or Love surface waves. The unwanted wavefields can contaminate seismic data acquired by seismic receivers. Although various conventional techniques exist to remove unwanted wavefields from seismic data, such techniques are relatively complex and may be costly.

### SUMMARY

In general, according to an embodiment, a method of performing seismic surveying comprises providing a plurality of sensor assemblies, where each of multiple ones of the plurality of sensor assemblies has a seismic sensor and a divergence sensor, and where the divergence sensor is used to measure noise. In addition, the plurality of sensor assemblies are arranged in a layout designed to acquire seismic signals in a target sampling pattern, where the layout is independent of provision of sensor assemblies for noise acquisition.

Other or alternative features will become apparent from the following description, from the drawings, and from the claims.

### BRIEF DESCRIPTION OF THE DRAWINGS

Some embodiments of the invention are described with respect to the following figures:

FIGS. 1, 2, and 5 illustrate conventional layouts of seismic sensors;

FIGS. 3, 4, and 6 illustrate layouts of seismic sensors according to some embodiments;

FIG. 7 is a schematic diagram of an example arrangement of sensor assemblies that can be deployed to perform a seismic survey, according to an embodiment; and

FIG. 8 illustrates a sensor assembly according to an embodiment that can be employed in the arrangement of FIG. 7.

### DETAILED DESCRIPTION

As used here, the terms “above” and “below”; “up” and “down”; “upper” and “lower”; “upwardly” and “downwardly”; and other like terms indicating relative positions above or below a given point or element are used in this description to more clearly describe some embodiments of the invention. However, when applied to equipment and methods for use in wells that are deviated or horizontal, such terms may refer to a left to right, right to left, or diagonal relationship as appropriate.

In accordance with some embodiments, a more efficient layout of sensor assemblies is provided to perform seismic surveying. The improved layout of sensor assemblies can provide one or more of the following benefits: reduced density of seismic sensors to perform full or wide azimuth surveying or three- or four-dimensional (3D or 4D) seismic surveying; no requirement for use of seismic source arrays; improved noise mitigation or cancellation; improved and more cost-efficient survey operation; and other benefits.

In some embodiments, each of multiple ones of the sensor assemblies has a seismic sensor and a divergence sensor, where the divergence sensor is used to measure noise. The sensor assemblies are arranged in a layout designed to acquire seismic signals in a target sampling pattern, where the layout is independent of provision of sensor assemblies for noise acquisition (in other words, the layout of sensor assemblies can be designed without having to consider positioning of sensor assemblies for acquiring noise to allow noise attenuation). Since each of the multiple sensor assemblies has a divergence sensor used to measure noise, signals received from such multiple sensor assemblies can be processed to cancel or mitigate coherent noise that may be present in a spread including the sensor assemblies. By providing the multiple sensor assemblies with respective divergence sensors to measure noise, the sensor assemblies can be laid out in an arrangement without any concern regarding positioning sensor assemblies for sampling noise.

As a result, a sparser (less dense) arrangement of sensor assemblies can be provided in the layout according to some embodiments as compared to conventional layouts, where additional sensor assemblies have to be positioned for sampling noise to allow for coherent noise cancellation. A sparser arrangement of sensor assemblies refers to an arrangement in which distances between sensor assemblies is greater than typically provided between sensor assemblies in a conventional layout.

In some embodiments, the divergence sensor is formed using a container filled with a material in which a pressure sensor (e.g., a hydrophone) is provided. The pressure sensor in such an arrangement is able to record mainly noise, such that the data from the pressure sensor in the sensor assemblies can be used to develop a noise reference model for cleansing seismic data acquired by the seismic sensors. The material in which the pressure sensor is immersed can be a liquid, a gel, or a solid such as sand or plastic.

One type of noise is ground-roll noise. Ground-roll noise refers to seismic waves produced by one or more seismic sources that travel generally horizontally along a ground surface towards seismic receivers. These horizontally traveling seismic waves, such as Rayleigh waves or Love waves, are undesirable components that can contaminate seismic data. Generally, “noise” refers to any signal component that is unwanted from seismic data (such as data representing reflected signals from subterranean elements). Other types of noise include flexural waves present in data acquired over frozen surfaces such as a body of water or permafrost; and airborne noise caused by the environment such as due to wind, rain, or human activity such as traffic, air blasts, flare noise or other industrial processes.

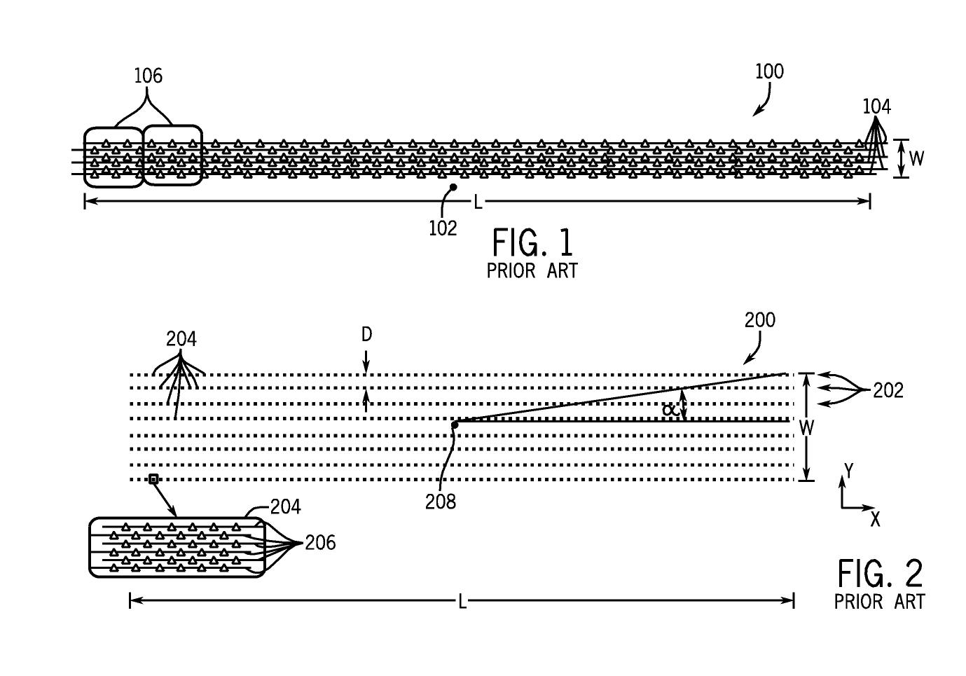

FIG. 1 illustrates an example conventional two-dimensional (2D) layout 100 of seismic sensors (represented by triangle Δ symbols). A width (W) of the layout 100 of seismic sensors is typically about 50 meters (m). The length (L) of the layout 100 can be between 8,000 m to 15,000 m.

A seismic source 102 is provided next to the layout 100 of seismic sensors. The layout 100 includes communication lines 104 (extending along the length of the layout) connecting respective sets of seismic sensors. In the example given in FIG. 1, the seismic sensors are grouped into respective sensor stations 106, where each sensor station 106 includes some number of seismic sensors (e.g., 12 to 72 sensors). Each sensor station includes sensors grouped together to output one channel to a central recording station.

FIG. 2 shows an example of a conventional three-dimensional (3D) layout 200 of seismic sensors. The 3D layout 200 allows for acquisition of seismic data in both the x and y directions as shown in FIG. 2. This is contrasted to the 2D layout 100 shown in FIG. 1, which performs acquisition in just the x direction. The layout 200 includes multiple receiver lines 202, where each receiver line 202 includes a row of sensor stations 204 (each sensor station 204 having 12 to 72 seismic sensors). As depicted in FIG. 2, each sensor station 204 includes a group of seismic sensors (represented by triangle Δ symbols) arranged on multiple corresponding communication lines 206. As with the FIG. 1 arrangement, each sensor station 204 outputs one channel to a central recording station.

FIG. 2 also shows a seismic source 208 that is provided near the center of the layout 200. The spacing between receiver lines 202 is represented by D, which typically ranges in value between 200 m to 300 m. The width (W) of the overall layout 200 can be about 4,000 m, which the length (L) of the layout 200 can be between 12,000 to 14,000 m. The aspect ratio W/L is about 4/12 to 4/14, which is about 0.33 or less.

The majority of the seismic data acquired by the sensors are in a narrow azimuth (as represented by the angle α in FIG. 2). However, some of the seismic data acquired by the sensors constitutes wide azimuth (large α), but at relatively small offset (relatively small distance between the seismic source 208 and a seismic sensor).

To achieve wider azimuth, full azimuth, or larger scale 3D seismic acquisition (with proper noise attenuation) using conventional layouts, relatively dense arrangements of seismic sensors would have to be provided, which can be prohibitively expensive, both in terms of hardware costs as well as labor costs associated with deploying the relatively large number of seismic sensors. With conventional layouts, seismic sensors have to be deployed in a certain geometrical pattern for sampling both signal and noise properly. Moreover, with conventional layouts, full azimuth or larger scale 3D seismic acquisition typically involves use of multiple seismic source points, typically arranged in an array, which also adds to complexity and costs.

In accordance with some embodiments, by using sensor assemblies that have both seismic sensors and divergence sensors (for noise measurement), the density of the sensor layout can be reduced, such that a wider azimuth (or even full azimuth) seismic survey can be achieved. Also, wide azimuth, full azimuth, or larger scale 3D seismic acquisitions can be performed without having to use an array of seismic sources—instead, a single seismic source point can be employed.

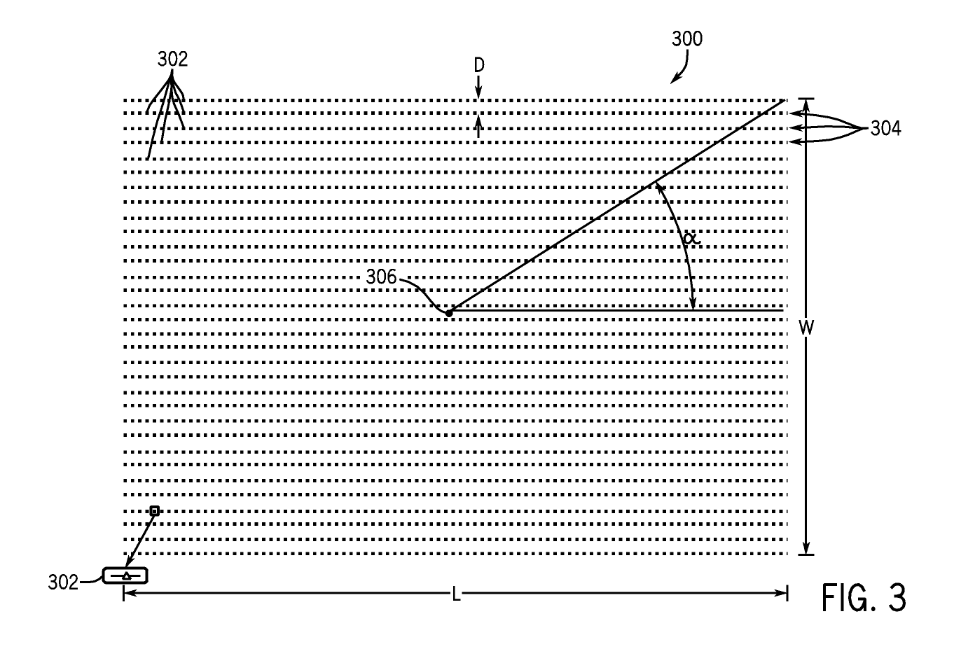

FIG. 3 illustrates an example of a layout 300 according to an embodiment in which each sensor station 302 can include just one sensor assembly according to some embodiments (where such sensor assembly includes both a seismic sensor and a divergence sensor). It is noted that not all of the sensor stations depicted in the layout 300 of FIG. 3 have to include sensor assemblies that include both a seismic sensor and a divergence sensor. Rather, a subset (or multiple ones) of all the sensor stations can include sensor assemblies that contain both a seismic sensor and a divergence sensor.

Although FIG. 3 shows that each sensor station 302 has just one sensor assembly, it is noted that in alternative embodiments multiple sensor assemblies can be provided in each sensor station 302, or multiple seismic sensors can be provided in each sensor assembly.

The layout 300 of FIG. 3 has more receiver lines 304 than the layout 200 shown in FIG. 2. As a result, the aspect ratio (W/L) of the layout 300 can range between 0.8 to 1, in some examples. This allows for a full azimuth, full offset survey to be achieved. In other words, full azimuth data (data for all angles of a can be acquired at all offsets, where offset refers to distance between a source and seismic sensor).

Note that although there is a larger number of receiver lines 304 in FIG. 3, the density of seismic sensors in the layout 300 can actually be substantially the same as or less than the density of seismic sensors 200 in FIG. 2. That is due to the fact that each sensor station 302 in the layout 300 has just one sensor assembly (containing a corresponding seismic sensor), while each sensor station 204 in the conventional layout 200 of FIG. 2 includes 12 to 72 seismic sensors. Thus, using the layout 300, wider azimuth or full azimuth seismic acquisition, or larger scale 3D sampling (including full 3D sampling) can be achieved with substantially the same density or smaller density than a conventional layout (such as layout 200 in FIG. 2) that provides limited scale 3D seismic acquisition. Full 3D sampling refers to sampling by seismic sensors at all points in a 2D acquisition area.

Using the layout 300 according to some embodiments, the intervals (D) between receiver lines 304 can be flexible, and can range between 25 m to 300 m, for example. Moreover, the intervals (D) between different pairs of receiver lines 304 can be varying. In other words, the interval (D) between a first pair of receiver lines 304 can have a first value, while the interval (D) between a second pair of receiver lines 304 can have a second, different value, and so forth.

As further shown in FIG. 3, a seismic source 306 is provided near the center of the layout 300. In other embodiments, instead of using just a single seismic source 306, multiple seismic sources (including source arrays) can be used with the layout 300. However, even though it is possible to use source arrays for flexibility, such arrays of sources do not have to be employed for noise attenuation. A single source point (e.g., 306 in FIG. 3) can be employed, such as a single vibrator, one weight-drop, one dynamite charge, and so forth. With layouts according to some embodiments, greater flexibility in the types of sources is provided. For example, a single seismic source can be used, a sparse arrangement of seismic sources can be used, or a dense arrangement of seismic sources can be used, depending upon the specific implementation and seismic acquisition goal.

By employing the layout 300 according to some embodiments, a smaller number of sensor assemblies can be used to provide a larger spread than can be accomplished using a conventional layout. Also, since a smaller number of sensor assemblies are used to achieve a larger spread, deployment of the sensor assemblies can be made faster and more efficient than using conventional techniques. A large spread area accomplished using layouts according to some embodiments can be implemented with relatively high-productivity shooting techniques, such as slip-sweep, ISS (independent simultaneous source), DSSS (distant separated simultaneous source), or other simultaneous source techniques. With the slip-sweep technique, a particular sweep of seismic source signaling begins without waiting for the previous sweep to complete. ISS or DSSS techniques employ simultaneous sources that are activated simultaneously.

With the more efficient layout provided by some embodiments of the invention, more convenient deployment in various different regions can be accomplished, such as in an open desert or in other regions.

The sensor assemblies can be deployed in a predetermined geometry, or the sensor assemblies can be deployed in random or pseudo-random geometric grids to achieve better random noise suppression, and/or to provide more even subterranean structure (e.g., reservoir) illumination.

In addition to providing 3D seismic surveying, 4D seismic surveying can be performed using layouts according to some embodiments. 4D seismic surveying is basically 3D seismic surveys performed repeatedly over different time periods.

In addition, for 3D deployment, wireless sensor assemblies without cables can be used (for cable-free sensor assemblies), where the sensor assemblies can communicate wirelessly. This will reduce the usage of physical materials such as cables, connectors, and so forth, to reduce the amount of resources used and to reduce costs. In some implementations, intermediate routers or concentrators may be provided at intermediate points of the network of sensor assemblies to enable communication between the sensor assemblies and a central recording station. Another type of cable-free sensor assembly includes a sensor assembly that includes local storage to store measurement data—the stored measurement data can be later collected manually, such as by connecting another device to the sensor assembly.

By using layouts according to some embodiments that provide for wide azimuth or full azimuth acquisition, or larger scale 3D (or even 4D) sampling, multiples can be cancelled or attenuated. “Multiples” refer to seismic energy that has been reflected more than once from various elements in the acquisition environment. With multiples cancelled, a clearer subsurface image can be acquired.

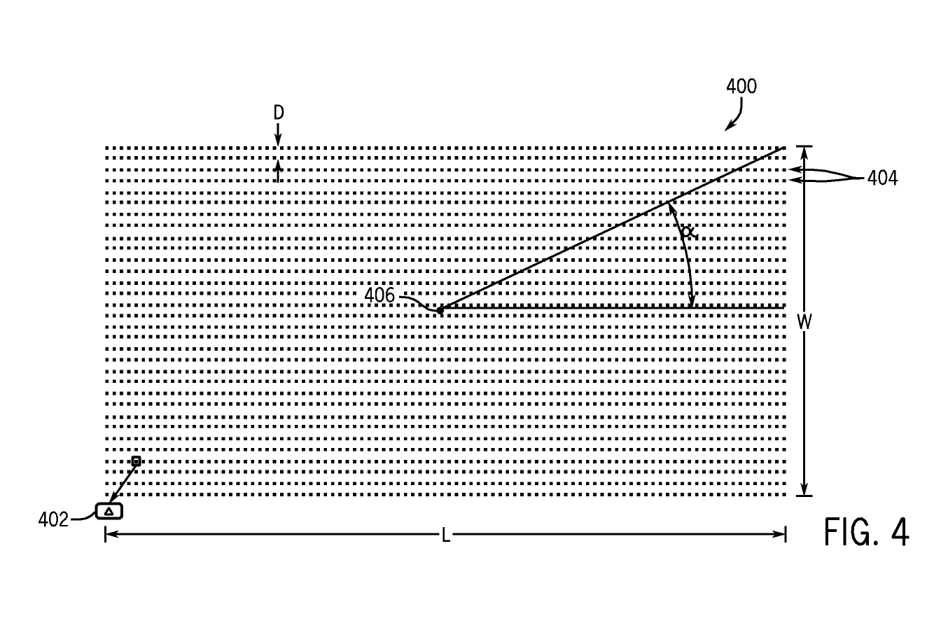

FIG. 4 illustrates another example layout 400 of seismic sensors (in sensor stations 402) that provides wide azimuth acquisition (as opposed to the full azimuth acquisition depicted in FIG. 3). The layout 400 includes multiple receiver lines 404 of sensor stations 402. In the layout 400, the aspect ratio (W/L) ranges between 0.5 to 0.8, for example (e.g., the width W of the layout 400 is smaller than the length L of the layout 300 in FIG. 3). Wide azimuth data can be acquired at certain offsets between the seismic source 402 and seismic sensors. The intervals (D) between receiver lines 404 can be flexible, and can range between 25 m to 300 m, for example. The intervals (D) between receiver lines 404 can also be varying, as discussed above in connection with FIG. 3. For example, the receiver line intervals can be smaller in regions corresponding to complex subterranean structures, and larger for regions associated with less complex subterranean areas.

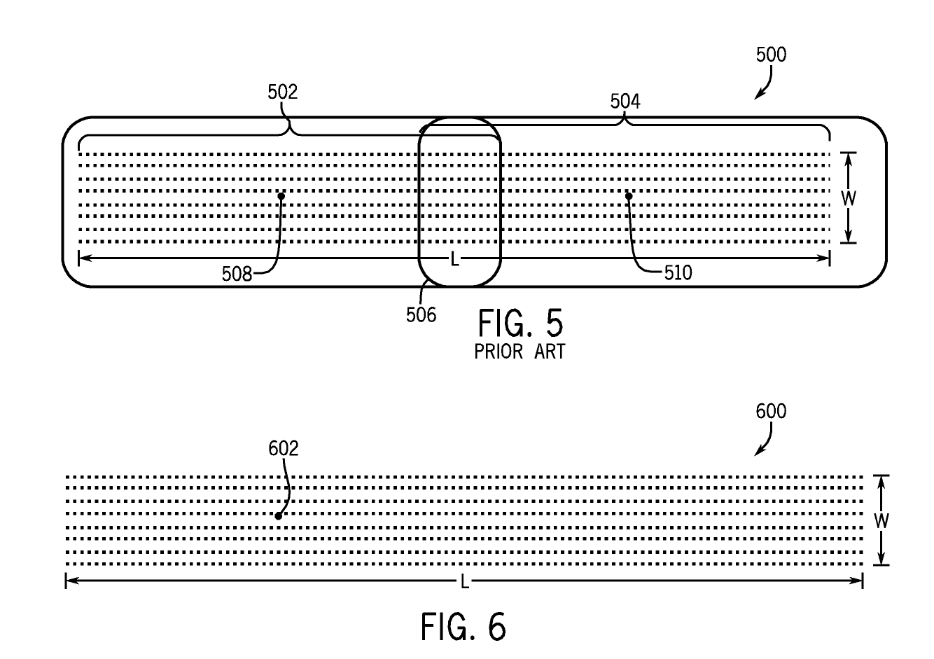

Using layouts according to some embodiments, overlapping of multiple spreads can be avoided to acquire seismic data in a relatively large geographic region. FIG. 5 depicts an example of a conventional approach in which two spreads 502 and 504 slightly overlap (represented by overlap region 506) to provide coverage for a desired geographic area having width W and length L. The spread 502 includes a seismic source 508, while the spread 504 includes a seismic source 510. The arrangement of FIG. 5 having overlapping spreads is referred to as a “zipper” arrangement. Each square dot in FIG. 5 represents a sensor stations similar to station 204 of FIG. 2 that has 12 to 72 seismic sensors

However, as depicted in FIG. 6, using a layout 600 with sensor assemblies according to some embodiments, overlap of multiple spreads can be avoided. The layout 600 has sensor assemblies that cover the same area (of width W and length L) as in FIG. 5, but with just one spread having a seismic sensor 602. This provides for improved efficiency. The arrangement depicted in FIG. 6 with no overlap is referred to as a “non-zipper” arrangement.

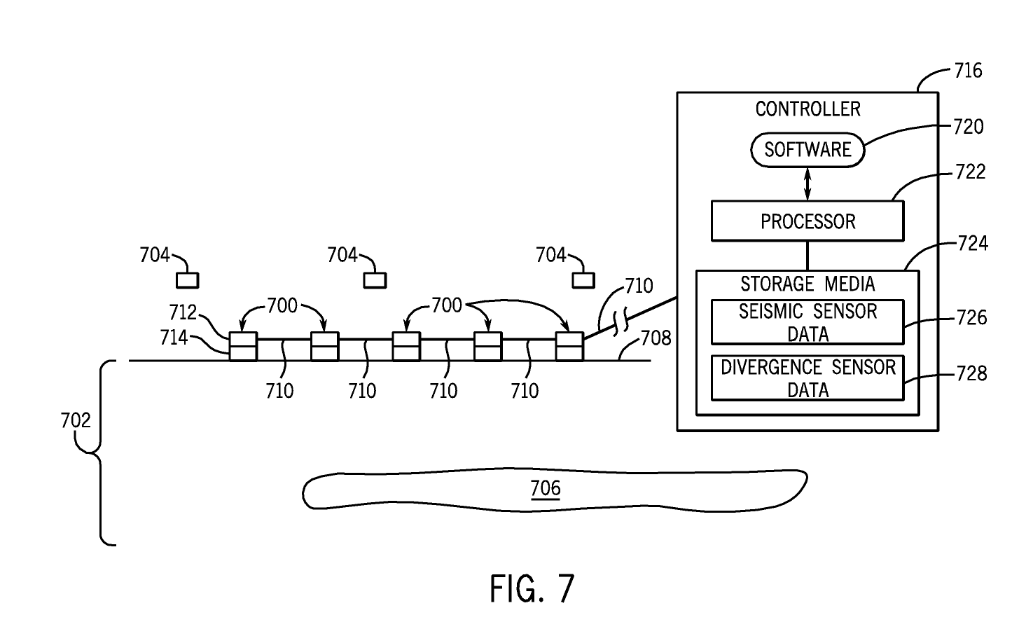

FIG. 7 is a schematic diagram of a line of sensor assemblies 700 according to some embodiments, where the sensor assemblies are usable in any of the layouts of FIGS. 3, 4, and 6. The sensor assemblies 700 are deployed on a ground surface 708. A sensor assembly 700 being “on” a ground surface means that the sensor assembly 700 is either provided on and over the ground surface, or buried (fully or partially) underneath the ground surface. The ground surface 708 is above a subterranean structure 702 that contains at least one subterranean element 706 of interest (e.g., hydrocarbon reservoir, freshwater aquifer, gas injection zone, etc.). One or more seismic sources 704, which can be vibrators, air guns, explosive devices, and so forth, are deployed in a survey field in which the sensor assemblies 700 are located.

Activation of the seismic sources 704 causes seismic waves to be propagated into the subterranean structure 702. Alternatively, instead of using controlled seismic sources as noted above to provide controlled source or active surveys, some embodiments can also be used in the context of passive surveys. Passive surveys use the sensor assemblies 700 to perform one or more of the following: (micro)earthquake monitoring; hydro-frac monitoring where microearthquakes are observed due to rock failure caused by fluids that are actively injected into the subsurface, such as a hydrocarbon reservoir; and so forth. Seismic waves reflected from the subterranean structure 702 (and from the subterranean element 706 of interest) are propagated upwardly towards the sensor assemblies 700. Seismic sensors 712 (e.g., geophones, accelerometers, etc.) in the corresponding sensor assemblies 700 measure the seismic waves reflected from the subterranean structure 702. Moreover, the sensor assemblies 700 further include divergence sensors 714 that are designed to measure noise, such as ground-roll noise or other types of noise. The data from the divergence sensors 714 can be employed to develop a noise reference model to attenuate noise in the measured seismic signals.

In one embodiment, the sensor assemblies 700 are interconnected by an electrical cable 710 to a controller 716 (e.g., central recording station). Alternatively, instead of connecting the sensor assemblies 700 by the electrical cable 710, the sensor assemblies 700 can communicate wirelessly with the controller 716. In some implementations, intermediate routers or concentrators may be provided at intermediate points of the network of sensor assemblies 700 to enable communication between the sensor assemblies 700 and the controller 716.

The controller 716 shown in FIG. 7 further includes processing software 720 that is executable on a processor 722. The processor 722 is connected to storage media 724 (e.g., one or more disk-based storage devices and/or one or more memory devices). In the example of FIG. 7, the storage media 724 is used to store seismic sensor data 726 communicated from the seismic sensors 712 of the sensor assemblies 700 to the controller 716, and to store divergence data 728 communicated from the divergence sensors 714 of the sensor assemblies 700.

In operation, the software 720 is used to process the seismic sensor data 726 and the divergence sensor data 728. The divergence sensor data 728 is combined with the seismic sensor data 726, using techniques discussed further below, to attenuate noise in the seismic sensor data 726 (to produce a cleansed version of the seismic sensor data). The software 720 can then produce an output to characterize the subterranean structure 702 based on the cleansed seismic sensor data 726.

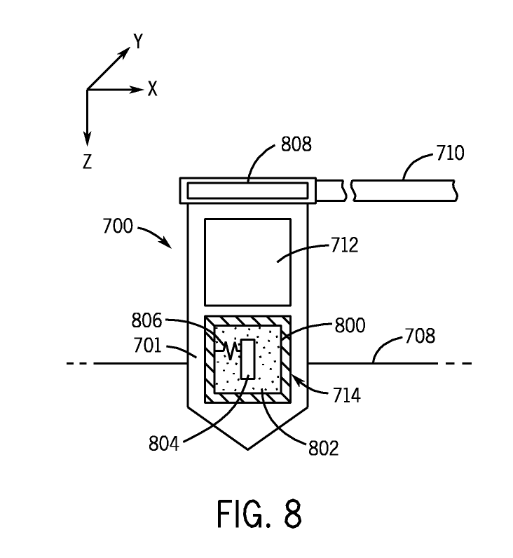

A sensor assembly 700 according to some embodiments is depicted in greater detail in FIG. 8. The seismic sensor 712 in the sensor assembly can be a geophone for measuring particle velocity induced by seismic waves in the subterranean structure 702, or alternatively, the seismic sensor 712 can be an accelerometer for measuring acceleration induced by seismic waves propagated through the subterranean structure 702.

In some embodiments, the seismic sensor 712 is a vertical component seismic sensor for measuring seismic waves in the vertical direction (represented by axis z in FIG. 7). In alternative embodiments, the sensor assembly 700 can additionally or alternatively include seismic sensors for detecting seismic waves in generally horizontal directions, such as the x or y directions that are generally parallel to the ground surface 708.

The divergence sensor 714 that is also part of the sensor assembly 700 (within a housing 701 of the sensor assembly 700) is used for measuring an input (e.g., noise) different from the seismic waves propagated through the subterranean structure 702 that are measured by the seismic sensor 712. In an alternative embodiment, the divergence sensor 714 of the sensor assembly 700 can be physically spaced apart from the seismic sensor 712 by some predetermined distance.

The divergence sensor 714 has a closed container 800 that is sealed. The container 800 contains a volume of liquid 802 (or other material such as a gel or a solid such as sand or plastic) inside the container 800. Moreover, the container 800 contains a hydrophone 804 (or other type of pressure sensor) that is immersed in the liquid 802 (or other material). The pressure sensor being immersed in the material means that the pressure sensor is surrounded by or otherwise attached to or in contact with the material. In the ensuing discussion, reference is made to the hydrophone 804 that is immersed in the liquid 802—note that in alternative embodiments, other types of pressure sensors can be immersed in other types of material. The hydrophone 804, which is neutrally buoyantly immersed in the liquid 802, is mechanically decoupled from the walls of the container 800. As a result, the hydrophone 804 is sensitive to just acoustic waves that are induced into the liquid 802 through the walls of the container 800. To maintain a fixed position, the hydrophone 804 is attached by a coupling mechanism 806 that dampens propagation of acoustic waves through the coupling mechanism 806.

Examples of the liquid 802 include the following: kerosene, mineral oil, vegetable oil, silicone oil, and water. In other embodiments, other types of liquids can be employed. A liquid with a higher viscosity can be used to change the sensitivity to different types of waves, including P (compression) waves, S (shear) waves, Rayleigh waves, and Love waves. Moreover, the amount of liquid 802 provided in the container 800 of the divergence sensor 714 determines the sensitivity of the hydrophone 804. A container 800 that is only partially filled with liquid records a weaker signal. In some embodiments, the container 800 can be partially filled with liquid to provide an expansion volume within the container 800. Expansion of the liquid 802, such as due to a temperature rise of the liquid 802, can be accommodated in the expansion volume (which can be filled with a gas).

As further shown in FIG. 8, the sensor assembly 700 also includes electronic circuitry 808 that is electrically coupled to both the seismic sensor 712 and the divergence sensor 714. The electronic circuitry 808 can include storage elements, processing elements, and communications elements for communicating data acquired by the seismic sensor 712 and divergence sensor 714 over the electrical cable 710 to the controller 716 (FIG. 7).

As depicted in FIG. 8, the seismic sensor 712 is positioned above and external to the container 800 of the divergence sensor 714. Alternatively, the seismic sensor 712 can have some other arrangement with respect to the divergence sensor 714. At least a portion of the divergence sensor 714 is below the ground surface 708, such that the hydrophone 804 is at or below the ground surface 708, but not above the ground surface 708. When planted, the divergence sensor 714 of the sensor assembly 700 is firmly in contact with the earth medium underneath the ground surface 708, which improves data quality of signals acquired by the hydrophone 804 in the divergence sensor 714.

In some embodiments, the seismic sensor 712 is a single-component seismic sensor for measuring a component of a seismic wavefield in just one direction, e.g., one of x, y, and z directions.

In embodiments that employ the cable 710, power is provided from a remote power supply (such as a power supply located at the controller 716) through the cable 710 to the sensor assemblies 700. In embodiments that employ wireless communications and that do not use the cable 710, the sensor assembly 700 can be provided with batteries to provide local power.

In some embodiments, the electronic circuitry 808 can include a processor to receive a first signal based on an output of the seismic sensor 712, and a second signal based on an output of the divergence sensor 714. The processor applies first and second digital filters to the first and second signals, respectively. Application of the first and second digital filters to the first and second signals causes production of a substantially zero output in response to input that includes just noise data detected at the seismic sensor and the pressure sensor.

“Substantially zero output” means that the output matches a reference (e.g., zero volts or some other reference voltage) to within some predefined tolerance, where the predefined tolerance is user-configurable (e.g. ±5%, ±10%, ±15%, etc.). Alternatively, the reference can be some non-level signature. Stated differently a substantially at zero output means that the output produced by the processor in response to the signals derived from outputs of the seismic sensor are at or close to the reference (to within some predefined tolerance, where the predefined tolerance is configurable by a user). In this manner, noise attenuation can be performed using the processor in the sensor assembly prior to output of data to the controller 716 (FIG. 7). Further details regarding such processor are described in U.S. patent application Ser. No. 12/757,103, entitled “SENSOR ASSEMBLY HAVING A SEISMIC SENSOR PRESSURE SENSOR, AND PROCESSOR TO APPLY FIRST AND SECOND DIGITAL FILTERS” (Attorney Docket No. 14.0506), filed 9 Apr. 2010, which is hereby incorporated by reference.

In another embodiment, the electronic circuitry 808 of FIG. 8 has at least one matching circuit that is connected to the output of at least one of the seismic sensor 712 and divergence sensor 714, where the at least one matching circuit is configured to suppress noise. The output of the at least one seismic sensor 712 or divergence sensor 714 is provided through the at least one matching circuit that applies predefined signal processing, such as signal amplitude adjustment, signal phase adjustment, signal integration, signal differentiation, and so forth. The output of the at least one matching circuit is connected to an electrical medium that connects a string of sensor assemblies to the controller 716 (FIG. 7).

More specifically, the electronic circuitry 808 includes two matching circuits, where a first matching circuit is connected to the output of the seismic sensor, and the second matching circuit is connected to the output of the pressure sensor. The matching circuits are configured to match characteristics of the outputs of the seismic sensor 712 and divergence sensor 714 such that the outputs can be combined for suppressing noise. Moreover, the matching circuits are designed to enhance noise suppression. As a result, the combined output (combination of outputs of the seismic and pressure sensors as modified by the respective matching circuits) that is provided to the electrical medium includes seismic data in which noise is suppressed.

The combining of the outputs of the matching circuits is accomplished using a combining circuit in the electronic circuitry 808. In one example, the combining circuit is a short circuit to hardwire the outputs of the matching circuits to the electrical medium. In other examples, other types of combining circuits configured to combine outputs of the matching circuits can be used. The combined signal (representing the combination of the outputs of the two matching circuits) contains the seismic data measured by the seismic sensor, with noise suppressed. Further details regarding the matching circuits and combining circuit are provided in U.S. patent application Ser. No. 12/720,188, entitled “STRING OF SENSOR ASSEMBLIES HAVING A SEISMIC SENSOR AND PRESSURE SENSOR” (Attorney Docket No. 14.0507), filed Mar. 9, 2010, which is hereby incorporated by reference.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method of performing seismic surveying, comprising:
providing a plurality of sensor assemblies, wherein each of multiple ones of the plurality of sensor assemblies has a seismic sensor and a divergence sensor, wherein the divergence sensor is used to measure noise; and
arranging the plurality of sensor assemblies in a layout designed to acquire seismic signals in a target sampling pattern, wherein the layout is independent of provision of sensor assemblies for noise acquisition.

2. The method of claim 1, further comprising:
performing wide azimuth seismic surveying using the layout of sensor assemblies.

3. The method of claim 1, further comprising:
performing full azimuth seismic surveying using the layout of sensor assemblies.

4. The method of claim 1, further comprising:
performing full azimuth, full offset seismic surveying using the layout of sensor assemblies.

5. The method of claim 1, further comprising:
performing full three-dimensional sampling using the layout of sensor assemblies, where the full three-dimensional sampling allows for multiple attenuation.

6. The method of claim 1, further comprising:
performing four-dimensional seismic surveying using the layout of sensor assemblies.

7. The method of claim 1, further comprising:
selectively using one of multiple seismic source techniques in conjunction with the layout of sensor assemblies based on a target goal.

8. The method of claim 1, further comprising:
using a single-point seismic source with the layout of sensor assemblies.

9. The method of claim 1, further comprising:
using a simultaneous source technique in conjunction with the layout of sensor assemblies.

10. The method of claim 1, wherein each of the multiple sensor assemblies are wireless sensor assemblies that are able to communicate wirelessly with a controller.

11. The method of claim 1, further comprising:
arranging at least some of the plurality sensor assemblies in a random or pseudo-random geometry to provide random noise suppression.

12. The method of claim 1, wherein in each of the multiple sensor assemblies:
the divergence sensor is positioned at or below a ground surface above a subterranean structure, the divergence sensor including a container containing a material and a pressure sensor immersed in the material, and
the seismic sensor is a single-component seismic sensor external to the container of the divergence sensor.

13. The method of claim 1, wherein in each of the multiple sensor assemblies:
electronic circuitry is provided for noise attenuation prior to outputting data from the corresponding sensor assembly to a central recording station.

14. A system for performing seismic surveying, comprising:
a plurality of sensor assemblies, wherein each of multiple ones of the plurality of sensor assemblies has a seismic sensor and a divergence sensor, wherein the divergence sensor is used to measure noise; and
arranging the plurality of sensor assemblies in a layout designed to acquire seismic signals in a target sampling pattern, wherein the layout is independent of provision of sensor assemblies for noise acquisition.

15. The system of claim 14, wherein each of the multiple ones of the plurality of sensor assemblies includes electronic circuitry to perform noise attenuation based on output from a corresponding divergence sensor.

16. The system of claim 14, further comprising:
a controller to receive outputs from the plurality of sensor assemblies, the controller configured to:
process outputs from the plurality of sensor assemblies to characterize a subterranean structure, and
perform noise attenuation based on outputs of the divergence sensors.

17. The system of claim 14, wherein the target sampling pattern comprises one of a wide azimuth acquisition pattern, a full azimuth acquisition pattern, full three-dimensional sampling, and four-dimensional sampling.

18. The system of claim 17, further comprising a single-point seismic source to perform seismic acquisition in the target sampling pattern.

19. The system of claim 14, wherein at least some of the plurality of sensor assemblies are arranged in a random or pseudo-random geometry to provide random noise suppression.

20. The system of claim 14, wherein in each of the multiple sensor assemblies:
the divergence sensor is for positioning at or below a ground surface above a subterranean structure, the divergence sensor including a container containing a material and a pressure sensor immersed in the material, and
the seismic sensor is a single-component seismic sensor external to the container of the divergence sensor.
